(19) United States
(12) Patent Application Publication
(10) Pub. No.: US 2017/0031954 A1
(43) Pub. Date: Feb. 2, 2017

(54) IMAGE ASSOCIATION CONTENT STORAGE AND RETRIEVAL SYSTEM

(71) Applicant: ALEXANDRE PESTOV, Toronto (CA)

(72) Inventor: ALEXANDRE PESTOV, Toronto (CA)

(21) Appl. No.: 14/810,052

(22) Filed: Jul. 27, 2015

(51) Int. Cl. G06F 17/30

(52) U.S. Cl. CPC G06F 17/30268; G06F 17/30528; G06F 17/30554; G06F 17/30442

(57) ABSTRACT

An image association content storage and retrieval system, wherein the system is comprised of a content creation process to create a piece of information with an image candidate; the image candidate is processed with an image association process and the piece of information with the image candidate is saved in a knowledge repository; the piece of information being retrieved from the knowledge repository by a user using a search engine; the system displays a set of search results comprising of a plurality of pieces of information being accompanied with a plurality of image associations; the set of search results being filtered by the user relies on visual association cues in the set of search results to find a relevant piece of information in an accelerated method of content retrieval.

### FIELD OF THE INVENTION

The present invention relates to computer based programs and more specifically to a system that functions for building image association content to store and to retrieve.

### BACKGROUND OF THE INVENTION

Capturing, retaining, sharing, searching, classifying, authenticating, and ascertaining data is a crucial objective for most entities such as individuals, groups, communities, enterprises and corporations. The proliferation of digital technology has led to widespread use of structured and unstructured digital knowledge repositories as knowledge formalization tools within companies and communities, including enterprise intranets and private wiki sites.

A typical digital knowledge repository allows for structured storage of information in the form of computer files or databases or distributed systems that contain text, graphical content, and other data. To organize the information, users of the system create textually-named units of organization corresponding to projects, collaborative groups, etc. Information may also be linked in a lower-level structure such as a “conversational” structure that allows multiple users to add comments or new information in a collaborative back and forth process.

Besides direct navigation of the repository and review of its textual structure and content, retrieval of information from a knowledge repository is typically done through a search function. Modern search functions take a partial or whole query text from the user, search the knowledge repository for entities which contain the text or have a name or other sort of label relating to it, and then present an organized list of results which may also contain additional semantic information or previews of the entities. Even with the most advanced modern search functions, knowledge repositories with large amounts of data may often return large sets of results, requiring users to perform a time-consuming manual review of the search results in order to locate their desired content.

There is a well-known phrase, “a picture is worth a thousand words” that encapsulates the superiority of visual images above written language for conveying information in human communication. Human visual processing is quick because the human brain has evolved to rapidly process visual patterns in a parallel fashion. Text, on the other hand, is information that must be processed serially—which is much slower. These facts of biology are being utilized in many fields related to information processing, including interaction design, data visualization (infographics), and visual analytics, and designs making heavy use of visual interfaces and visual presentation of information are pervasive in the explosive growth of social media applications. Augmenting the text-based navigation and search systems of a knowledge repository to utilize images is therefore highly desirable.

The most commonly used information retrieval method in private databases is the well-known text keyword or text phrase query, using a search engine. There are other methods of search, such as relying on human indexing of the information or meta search of search algorithms to provide results, but none of these obviates the need for time-ineffective human review and refinement of search results.

Currently employed methods are unable to filter search results and provide only the information that the user is interested in with absolute accuracy. The reasons for this include the existence and difficulty of processing search queries involving ambiguous and incomplete information. Because of this possibility, in order to avoid filtering out the information that a user requests, information retrieval methods must often provide statistically similar results to the desired content that the user is looking for to ensure that the desired content is somewhere within the results. Usually, the quantity of results is large and the user must perform a manual review of the search results to find the exact content desired.

The information retrieval system proposed in the present invention associates semantically related images with content and presents those images to the user during the navigation and search of the knowledge repository. This approach leverages the human user's associative memory and capability for fast image processing to enable them to quickly find the exact piece of information that is being searched for within a set of search results. If the user querying for a piece of information was the one who entered it into the database, then that person will have associated an image to the information and can quickly find the information by visually looking through the search results for that image. If the user is querying for information that they did not personally enter, or if they fail to recall the associated image from memory, the semantic relation between images and content provides visual cues, directing the user to the correct information.

### SUMMARY OF THE INVENTION

An image association content storage and retrieval system, wherein said system comprising of a content creation process to create a piece of information with an image candidate; a content editing process to edit a piece of information and add an image candidate; said image candidate is processed with an image association process; said piece of information with said image candidate saved in a knowledge repository; said knowledge repository contains a plurality of pieces of information accompanied by a plurality of said image candidates; said piece of information being retrieved from said knowledge repository by a user using a search engine; said system displays a set of search results comprising of a plurality of pieces of information being accompanied with a plurality of image associations; said set of search results being filtered by said user; and said user relies on visual association cues in said set of search results to find a relevant piece of information in accelerated content retrieval.

The present invention provides a method for building digital private knowledge repositories with accelerated content retrieval by associating images with content (“image-tags”), intended for use in community-based (e.g. group, enterprise, project, etc.) social networks, intranets, and other systems.

A method of building private (e.g. individual, group, community, enterprise) knowledge repositories with image-context association that enables acceleration of information access and discovery in such knowledge repositories.

The present invention stores a variety of types of information using industry standard database technology. The present invention performs searches of the database in a standard way, using keyword or phrase queries.

The present invention differs from all others in the association of images to the content being stored. The present invention produces those images in the search results, associated with the content being searched for, allowing for human visual pattern matching to be applied to rapidly find the desired content within the search results.

To be useful, knowledge repositories must contain volumes of information. However, searching for content in extensive knowledge repositories returns many results mainly composed of text that has to be reviewed and sorted manually by the user. The human brain processes text relatively slowly. Thus, reviewing search results takes time proportional to the quantity of results. The present invention accelerates the manual review of the computer generated search results.

Currently, most searches for content provide text as search results. This text has then to be reviewed manually by users. There are no effective method that speeds up this manual review of the search results. The present invention does provide such a method by leveraging the parallel visual processing that users can perform.

Businesses that maintain large amounts of content or knowledge are prime candidates for the present invention. Health care providers, for instance, could benefit from the use of the present invention by using pictures of ailments as the associated images to help medical practitioners search through results in medical databases to hone in on treatment or diagnostic information.

Businesses that deal with large numbers of products, equipment, or other materials could benefit by using the pictures of these objects as the associated images that are to be visually searched through to hone in on content.

The present invention encourages users to store often-needed information. The result within a company will be that over time the employees can crowd-source a knowledge repository that encapsulates the knowledge of departments, projects, and jobs. Such a repository will allow for quick training of new staff, with managers of departments using the present invention to set up training material for employees under their department.

Business owners would appreciate the encapsulation of useful, non-formalized knowledge relating to their business and its operations, as this would protect the company from losing critical information when employees who have amassed a large personal knowledge base leave the company.

Studies have shown that workers spend a significant part of their day searching for information. The present invention can cut down on that search time and significantly increase productivity.

The majority of the focus on content retrieval has been in the area of improving the automatic searching of databases and machine-based, algorithmic retrieval of relevant results. The majority of the work and time saved by the present invention is in improving the subsequent manual human review of those search results.

The quantity of information stored in knowledge repositories—and therefore also the size of typical search results—has been relatively small up until recently, so human searching of computer search results has only recently become a significant problem.

Historically the amount of resources required for responsive interfaces based on images rather than text has also been very high compared to the manual human review step of the search process.

Other objects, features, and advantages of the present invention will be readily appreciated from the following description. The description makes reference to the accompanying drawings, which are provided for illustration of the preferred embodiment. However, such embodiments do not represent the full scope of the invention.

### BRIEF DESCRIPTION OF THE DRAWINGS

Embodiments herein will hereinafter be described in conjunction with the appended drawings provided to illustrate and not to limit the scope of the claims, wherein like designations denote like elements, and in which:

FIG. 1 shows a content creation process diagram of the present invention;

FIG. 2 shows an image association process diagram of the present invention;

FIG. 3 shows a schematic diagram of the image association process of the present invention;

FIG. 4 shows a search process diagram of the present invention; and

FIG. 5 shows a schematic diagram of the search result of the present invention.

### DETAILED DESCRIPTION OF THE DRAWINGS

In the following description, the flowcharts illustrate various embodiments of the present invention. The illustrated embodiments are examples and do not limit the scope of the claims.

The embodiments of the present invention provide a system and a method for building digital private knowledge repositories to accelerate content retrieval by associating images to the content.

An article and a note are a written work published in an electronic form. It may be for variety of purposes such as news, research results, reports, academic analysis or debate. It can contain photographs, accounts, statistics, graphs, recollections, interviews, polls, debates on the topic, etc.

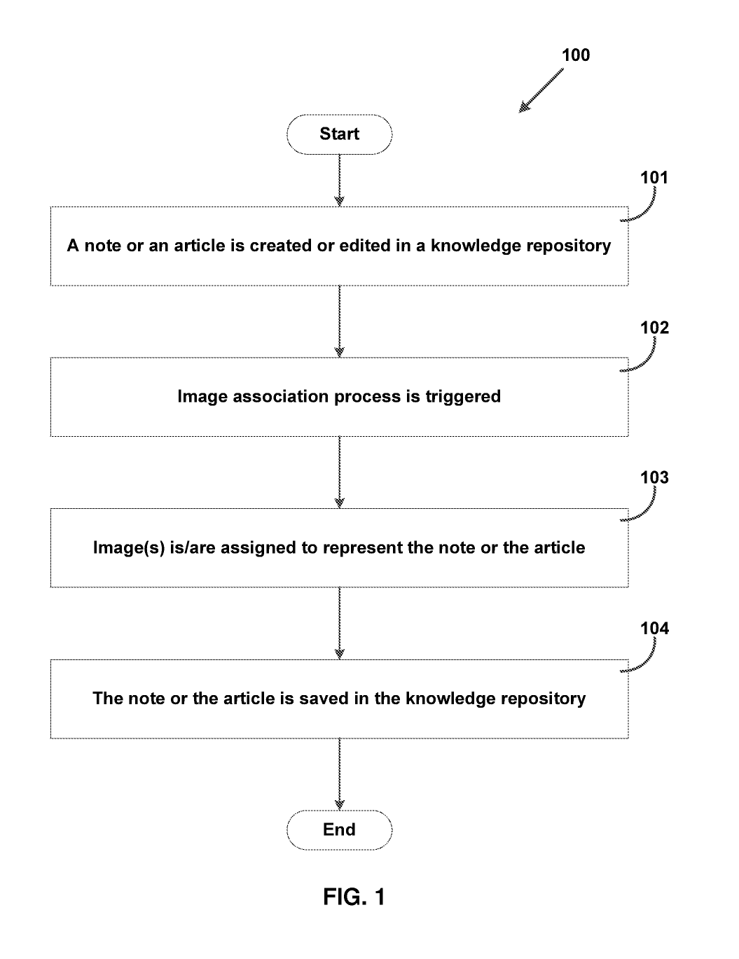

As shown in FIG. 1, the content creation process 100 of the present invention comprises of steps of creating or editing a note or an article 101 by a user in a computer program which is stored in a knowledge repository. The Image association process is triggered 102 after the creation or editing of the note or the article. One image or a plurality of images is assigned 103 to the note or the article. The note or the article is saved in the knowledge repository 104.

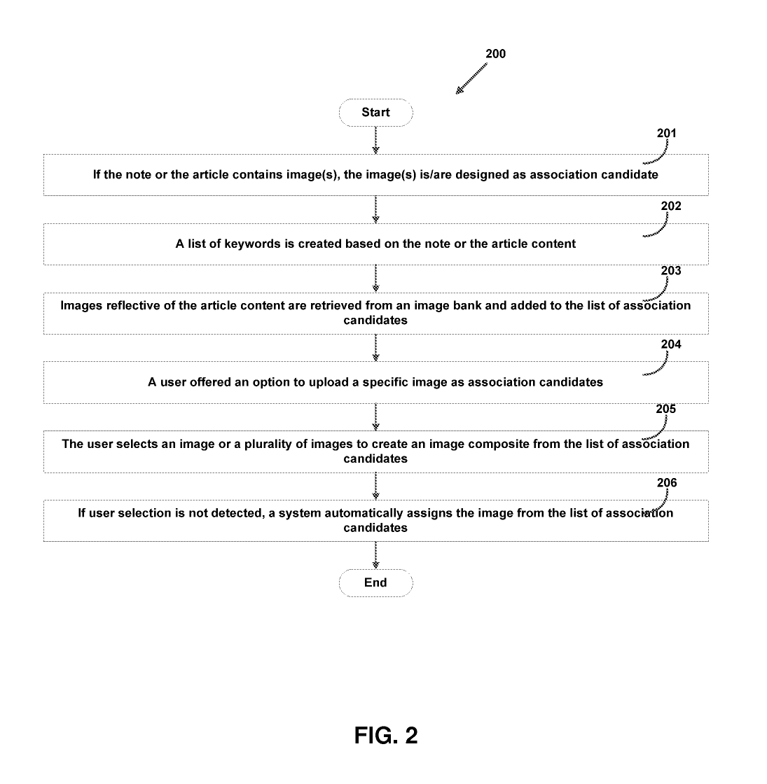

Associating an image or a plurality of images with the content is the key factor of the present invention to accelerate content retrieval. The image association process 200 which is shown in FIG. 2 can be done semi-automatically with the user or automatically with the system. If the note or the article contains images, the image(s) in the note or article can be used for image association 201. In the other embodiment, if the article or the note does not have any images, the system is created with a list of keywords based on the content of the article or the note 202, the image reflecting the list of keywords are retrieved from an image bank and added to the list of association image candidates for the specific article or note 203.

Again as shown in FIG. 2 of the present invention, the user can upload a specific image or a plurality of images 204 for the article or the note to be added to the article. The user can select a candidate image 205 to be assigned to the article or the note and save the article or the note with the image candidate which is retrieved during a search process. The proposed images are stored in the knowledge repository and are to be assigned to the note or the article by the user.

Again as shown in FIG. 2, if the image association process did not detect any image assignment to the article or the note, the system automatically assigns 206 an image or a plurality of images based on the list of keywords for retrieval of the article or the note. It may also be possible to rebuild previous content data bases in the knowledge repository and execute the image association process to increase the accuracy of the search results. It would be beneficial for such a data base to be able to generate search tags that describe the content of the image.

Another embodiment of the present invention which makes it more flexible is the inclusion of multiple images associated with a single piece of content. This allows the user to separate out similar pieces of content with multiple images when doing a search in the knowledge repository.

An image bank referred in the present invention can be selected from different groups of images such as images uploaded from a digital camera, or uploaded from a storage device or uploaded from online sources. For example, a reporter can assign an image or a plurality of images to an article to accelerate content retrieval, by selecting an image candidate from the article, or uploading from a personal digital camera, or uploading from storage devices or finding images online or internet based on the content of the article through a website such as Google images.

The image association process of the present invention can access multiple sources of images such as images stored on storage devices, on-line sources of images such as google image or Dropbox. The term “image bank” in the present invention referred to all available sources of images for the system to select and assign the image(s) to the article.

As used in the present specification and in the appended claims, the term “knowledge repository” suggests a memory in the form of volatile memory, disc drive, or non-volatile memory including flash memory, on-board or captive digital memory, or removable digital memory such as SD cards or portable disc drives or on-line storage systems such as cloud technology to store and maintain a plurality of articles or notes and to be accessed for retrieval by a user to search for a specific article or note.

As used in the present specification and in the appended claims, the term “keyword” may refer to a word which occurs in a text more often than we would expect to occur by chance alone. The user can select and suggest the keyword(s) to the system or the system can select specific keywords from the content by comparing the quantity of the words which present in the content more than other words.

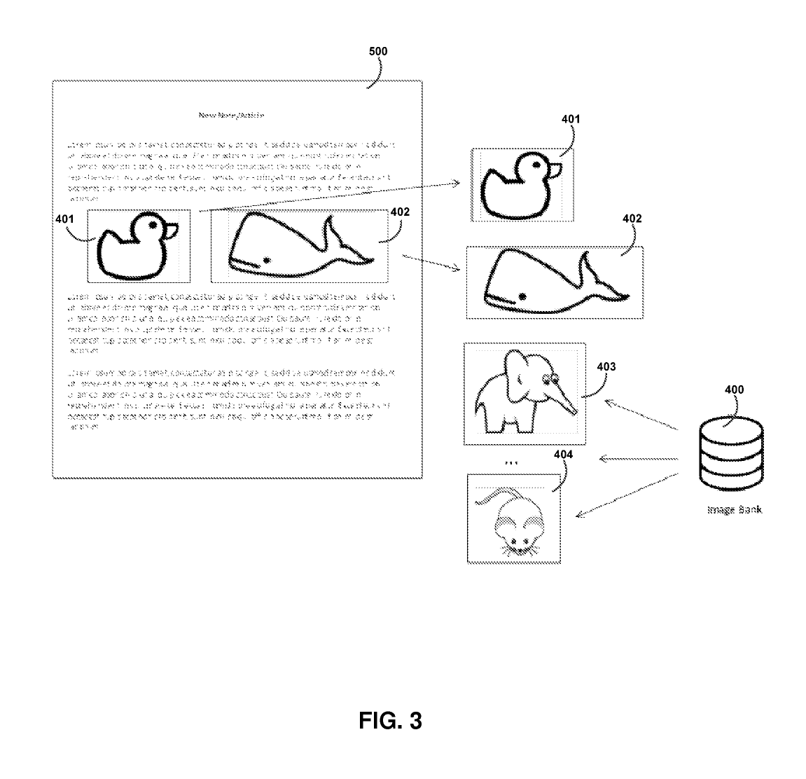

FIG. 3 shows a schematic diagram for the image association process by a user or system based on the title of the article 500 and the list of keywords in the article 500. The image bank 400 may suggest a plurality of images 401-404 based on user preferences or list of keywords. The user or the system can select from the suggested images 401-404 and place one image 401 or more than one image 401-402 into the metadata of the article 500 to be retrieved by a search query by a user.

The selected images 401-402 can be placed in some part of the article or the assigned images 401-402 can be hidden in the original article 500 and just be used as a hint to help visual cues for the user to retrieve the content and find the specific article 500 from the search results.

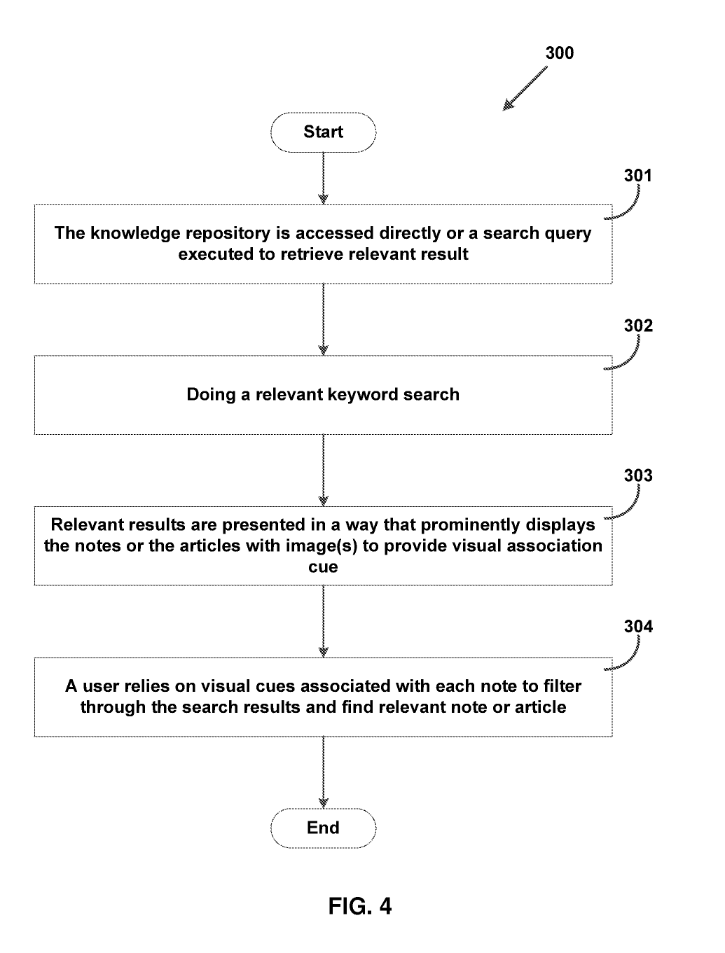

The search process 300 of the present invention is shown in FIG. 4. The search process is executed within the articles or notes with assigned images in the knowledge repository. The search process algorithm 300 comprises steps of accessing the knowledge repository 301 by a user; doing a search with relevant keywords 302; presenting related articles with assigned images 303, and filtering the search result by the user 304 based on the visual cues associated with each article or note in the search result.

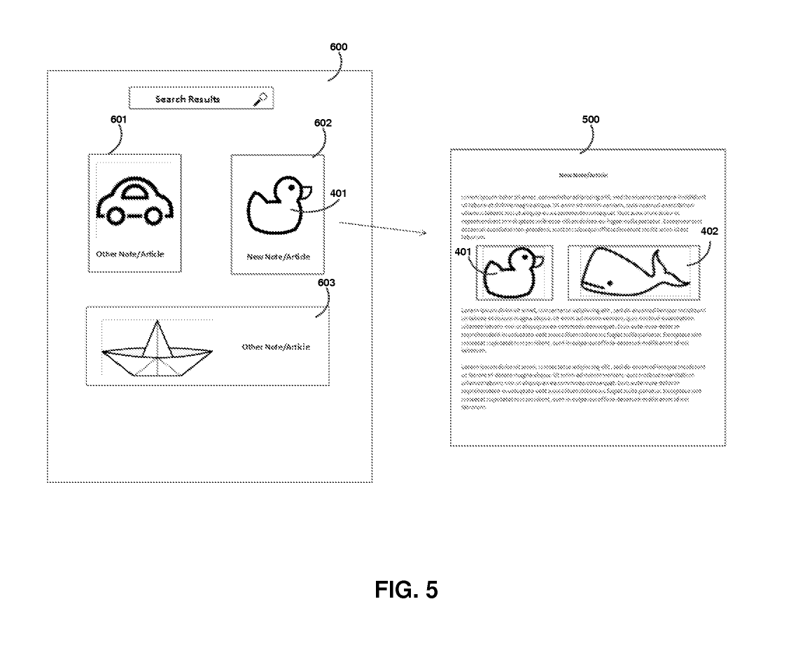

As shown in FIG. 5, a user can do a search by using specific keywords in the knowledge repository to find an article, the search result 600 is illustrated which comprises of a short description of the article with an image 601-603. Then the user can find the specific article 602 based on the visual cue (image 401 assigned to the article 500) between the articles in the search result page 600.

The forgoing is considered as illustrative only of the principles of the invention. Further, since numerous modification and changes will readily occur to those skilled in the art, it is not desired to limit the invention to the exact construction and operation shown and described, and accordingly, all suitable modifications and equivalents may be resorted to, filling within the scope of the invention.

With respect to the above description, it is to be realized that the optimum relationship for the parts of the invention in regard to size, shape, form, materials, function and manner of operation, assembly and use are deemed readily apparent and obvious to those skilled in the art, and all equivalent relationships to those illustrated in the drawings and described in the specification are intended to be encompassed by the present invention.

What is claimed is:

1. An image association content storage and retrieval system, wherein said system comprises:
a. a content creation process to create a piece of information with an image candidate;
b. a content editing process to edit a piece of information and add an image candidate;
c. said image candidate is processed with an image association process;
d. said piece of information with said image candidate saved in a knowledge repository;
e. said knowledge repository contains a plurality of pieces of information accompanied by a plurality of said image candidates;
f. said piece of information being retrieved from said knowledge repository by a user using a search engine;
g. said system displays a set of search results comprising of a plurality of pieces of information being accompanied with a plurality of image associations;
h. said set of search results being filtered by said user; and
whereby said user relies on visual association cues in said set of search results to find a relevant piece of information in accelerated content retrieval.

2. The image association content storage and retrieval system of claim 1, wherein said image association process comprises steps of:
a. selecting an association image candidate from said piece of information;
b. selecting an association image candidate from an image bank based on a list of keywords; and
c. nominating and assigning an image composite from said association image candidates to said piece of information.

3. The image association content storage and retrieval system of claim 2, wherein said image bank being selected from the groups consisting of a digital camera, a storage device, and an online source.

4. The image association content storage and retrieval system of claim 2, wherein said image composite being selected based on semantic relationships between said list of keywords and said association image candidates.

5. The image association content storage and retrieval system of claim 1, wherein said knowledge repository being selected from the groups consisting of:
a. a volatile memory;
b. a non-volatile memory;
c. a removable digital memory; and
d. an on-line storage system.

6. The image association content storage and retrieval system of claim 1, wherein said set of search results comprises of a plurality of short descriptions of said pieces of information accompanied by a plurality of said image candidates based on a keyword-search on said search engine.

7. The image association content storage and retrieval system of claim 6, wherein said keyword-search being selected from the groups consisting of a standard keyword and a phrase query.

8. The image association content storage and retrieval system of claim 1, wherein said set of search results provides a parallel visual process to accelerate performance of the search process.

9. The image association content storage and retrieval system of claim 1, wherein said image candidate being a plurality of said image candidates.

10. The image association content storage and retrieval system of claim 1, wherein a plurality of said image candidates being assigned to said piece of information.

11. The image association content storage and retrieval system of claim 1, wherein said piece of information being selected from the groups consisting of a news article, research results, a report, an academic analysis, an analysis and a debate.

12. An image association content storage and retrieval method, wherein said method comprising steps of:
a. creating process of a piece of information with an image candidate;
b. editing process of a piece of information with an image candidate;
c. processing said image candidate with an image association process;
d. saving said piece of information with said image candidate in a knowledge repository;
e. retrieving said piece of information from said knowledge repository by a user using a search engine;
f. displaying a set of search results comprising of a plurality of pieces of information being accompanied with a plurality of image associations;
g. filtering said set of search results by said user; and
whereby said user relies on visual association cues in said set of search results to find a relevant piece of information in an accelerated content retrieval method.

13. The image association content storage and retrieval method of claim 12, wherein said image association process comprises steps of:
a. selecting an association image candidate from said piece of information;
b. selecting an association image candidate from an image bank based on a list of keywords; and
c. nominating and assigning an image composite from said association image candidates to said piece of information.

14. The image association content storage and retrieval method of claim 13, wherein said image bank being selected from the groups consisting of a digital camera, a storage device, and an online source.

15. The image association content storage and retrieval method of claim 13, wherein said image composite being selected based on a semantic relationship between said list of keywords and said association image candidates.

16. The image association content storage and retrieval method of claim 12, wherein said knowledge repository being selected from the groups consisting of:
a. a volatile memory;
b. a non-volatile memory;
c. a removable digital memory; and
d. an on-line storage system.

17. The image association content storage and retrieval method of claim 12, wherein said set of search results comprises of a plurality of short descriptions of said pieces of information accompanied by a plurality of said image candidates based on a keyword-search on said search engine.

18. The image association content storage and retrieval method of claim 17, wherein said keyword-search being selected from the groups consisting of a standard keyword and a phrase query.

19. The image association content storage and retrieval method of claim 12, wherein a plurality of said image candidates being assigned to said piece of information.

20. The image association content storage and retrieval method of claim 12, wherein said piece of information being selected from the groups consisting of a news, a research, a research results, a report, an academic analysis, an analysis and a debate.
